(19) United States
(12) Patent Application Publication
(10) Pub. No.: US 2024/0056292 A1
(43) Pub. Date: Feb. 15, 2024

(54) ELECTRONIC DEVICE FOR PROVIDING BIDIRECTIONAL KEY EXCHANGE PROTOCOL ON BASIS OF LOCATION AND OPERATION METHOD THEREOF

(71) Applicant: AGENCY FOR DEFENSE DEVELOPMENT, Daejeon (KR)

(72) Inventors: Ik Rae JEONG, Seoul (KR); Jin Wook BYUN, Pyeongtaek-si (KR); Jae Yeol JEONG, Seoul (KR); Chang Won LEE, Daejeon (KR); Myung Kil AHN, Daejeon (KR)

(21) Appl. No.: 18/038,844

(22) PCT Filed: Dec. 23, 2020
(86) PCT No.: PCT/KR2020/019021

§ 371 Date: May 25, 2023

(30) Foreign Application Priority Data
Nov. 26, 2020 (KR) 10-2020-0161239

(51) Int. Cl. H04L 9/08; H04L 67/52

(52) U.S. Cl. CPC H04L 9/0844; H04L 67/52; H04L 2209/42; H04L 2209/84

(57) ABSTRACT

Provided is an electronic device, including a database and a processor, and the processor is configured to receive a user ID, at least one anonymous user ID corresponding to the user ID and location information of a user terminal from the user terminal, receive an unmanned aerial vehicle (UAV) ID, at least one anonymous UAV ID corresponding to the UAV ID and location information of an UAV from the UAV, and in response to receiving key exchange request information from the user terminal or the UAV, provide a key exchange protocol between the user terminal and the UAV based on the location information of the user terminal and the location information of the UAV.

### TECHNICAL FIELD

This disclosure relates to an electronic device for providing a location-based bidirectional key exchange protocol, and a method of operating the same. Specifically, the present disclosure relates to a method for providing a location-based bidirectional key exchange protocol between an unmanned aerial vehicle (UAV) (e.g., a drone) and a user terminal, and a device thereof.

### BACKGROUND ART

An UAV (e.g., a drone) is a powered vehicle that may be remotely controlled or automatically flown using a GPS device without a pilot directly on board, and the range of UAV usage is expanding not only for military purposes but also for various fields such as video shooting, delivery service, pesticide spraying, intelligent traffic management and 3D map information acquisition. UAVs may be connected to use a user's or an administrator's terminal in a bidirectional communication method and may transmit/receive predetermined information or commands to/from the terminal.

### DISCLOSURE OF INVENTION

### Technical Goals

A user may use a user terminal to be connected to a UAV waiting in a nearby location or in flight through bidirectional communication, and may transmit/receive information. Bidirectional communication may be performed through key exchange between the user terminal and the UAV via a server through a single user ID and a single UAV ID registered in the server. However, in this case, privacy issues cannot be avoided due to exposure of unchangeable user ID or UAV ID information.

Accordingly, a method of using an anonymous user ID in place of a fixed user ID (or UAV ID) is being reviewed. However, even in this case, since one anonymous user ID corresponding to one user ID is used, the actual user may be traced according to the information of the time or place where the anonymous ID was used, and thus the method is not a complete solution to the privacy invasion problem.

Communication connection is possible only when the user terminal wishes a bidirectional connection with a specific UAV, but it is impossible to perform bidirectional communication if the UAV requests key exchange to the user terminal. However, as the need emerges that an UAV which autonomously flies and obtains predetermined image information provides information to a user terminal within an adjacent range, there is a demand for technology that an UAV first requests a key exchange to a user terminal.

According to various example embodiments, strong anonymity is guaranteed in bidirectional communication between a user terminal and an UAV since provided is an electronic device that provides a protocol that allows the UAV to request key exchange first to the user terminal and a location-based key exchange protocol, and provided is a method related thereto.

### Technical Solutions

According to an aspect, there is provided an electronic device, including a database and processor, wherein the processor is configured to receive a user ID, at least one anonymous user ID corresponding to the user ID and location information of a user terminal from the user terminal, receive an unmanned aerial vehicle (UAV) ID, at least one anonymous UAV ID corresponding to the UAV ID and location information of an UAV from the UAV, and in response to receiving key exchange request information from the user terminal or the UAV, provide a key exchange protocol between the user terminal and the UAV based on the location information of the user terminal and the location information of the UAV.

According to another aspect, there is also provided a method of providing a location-based bidirectional key exchange protocol, including registering user information corresponding to at least one user terminal based on user ID information received from the at least one user terminal, registering at least one UAV information based on UAV ID information received from at least one UAV, receiving location information on at least one of the at least one user terminal or the at least one UAV, and in response to receiving key exchange request information from any one of the at least one user terminal and the at least one UAV, providing a key exchange protocol between any one of the at least one user terminal and any one of the at least one UAV based on the location information.

According to another aspect, there is also provided a computer-readable non-transitory recording medium having a program for executing a method for providing a location-based bidirectional key exchange protocol on a computer, wherein the method for providing a location-based bidirectional key exchange protocol includes registering user information corresponding to at least one user terminal based on user ID information received from the at least one user terminal, registering at least one UAV information based on UAV ID information received from at least one UAV, receiving location information on at least one of the at least one user terminal or the at least one UAV, and in response to receiving key exchange request information from any one of the at least one user terminal and the at least one UAV, providing a key exchange protocol between any one of the at least one user terminal and any one of the at least one UAV based on the location information.

### Effects

According to example embodiments, it is possible to provide a bidirectional key exchange protocol with improved security in an Internet of drones (IoD) environment. More specifically, provided are improved system, devices and methods that are related not only to automatically suggesting a device to connect based on a location but also to an UAV performing a key exchange request first.

### BRIEF DESCRIPTION OF DRAWINGS

FIG. 1 is a block diagram of a system for providing a location-based bidirectional key exchange protocol according to an example embodiment.

FIG. 2 is a flowchart illustrating a method for providing a key exchange protocol between a user terminal of an electronic device and an UAV according to an example embodiment.

FIG. 3 is a flowchart of a method of registering a user ID according to an example embodiment.

FIG. 4 is a flowchart of a method of registering an UAV ID according to an example embodiment.

FIGS. 5A and 5B are flowcharts of a method for transmitting location information of a user terminal according to an example embodiment.

FIGS. 6A and 6B are flowcharts of a method for transmitting location information of an UAV according to an example embodiment.

### BEST MODE FOR CARRYING OUT THE INVENTION

Hereinafter, example embodiments of the present disclosure will be described in detail with reference to the accompanying drawings.

In describing the example embodiments, descriptions of technical contents that are well known in the technical field to which the present disclosure pertains and that are not directly related to the present disclosure will be omitted. This is to more clearly convey the gist of the present disclosure without obscuring the gist of the present disclosure by omitting unnecessary description.

For the same reason, some elements are exaggerated, omitted or schematically illustrated in the accompanying drawings. In addition, the size of each element does not fully reflect the actual size. In each figure, the same or corresponding elements are assigned the same reference numerals.

Advantages and features of the present disclosure, and a method of achieving the advantages and the features will become apparent with reference to the example embodiments described below in detail together with the accompanying drawings. However, the present disclosure is not limited to the example embodiments disclosed below, and may be implemented in various different forms. The example embodiments are provided only so as to render the present disclosure complete, and completely inform the scope of the present disclosure to those of ordinary skill in the art to which the present disclosure pertains. The present disclosure is only defined by the scope of the claims. Like reference numerals refer to like elements throughout.

In this case, it will be understood that each block of a flowchart diagram and a combination of the flowchart diagrams may be performed by computer program instructions. The computer program instructions may be embodied in a processor of a general-purpose computer or a special purpose computer, or may be embodied in a processor of other programmable data processing equipment. Thus, the instructions, executed via a processor of a computer or other programmable data processing equipment, may generate a part for performing functions described in the flowchart blocks. To implement a function in a particular manner, the computer program instructions may also be stored in a computer-usable or computer-readable memory that may direct a computer or other programmable data processing equipment. Thus, the instructions stored in the computer usable or computer readable memory may be produced as an article of manufacture containing an instruction part for performing the functions described in the flowchart blocks. The computer program instructions may be embodied in a computer or other programmable data processing equipment. Thus, a series of operations may be performed in a computer or other programmable data processing equipment to create a computer-executed process, and the computer or other programmable data processing equipment may provide steps for performing the functions described in the flowchart blocks.

Additionally, each block may represent a module, a segment, or a portion of code that includes one or more executable instructions for executing a specified logical function(s). It should also be noted that in some alternative implementations the functions recited in the blocks may occur out of order. For example, two blocks shown one after another may be performed substantially at the same time, or the blocks may sometimes be performed in the reverse order according to a corresponding function.

In this case, the term “— part” used in the example embodiments refers to software or hardware components such as a field programmable gate array (FPGA) or an application specific integrated circuit (ASIC) and performs predetermined roles. However, the term “— part” is not a meaning limited to software or hardware. The “— part” may be formed to be stored in an addressable storage medium or to reproduce one or more processors. Thus, as an example, the “— part” includes components such as software components, object-oriented software components, class components, and task components, and processes, functions, attributes, procedures, sub-routines, segments of a program code, drivers, firmware, microcodes, circuits, data, database, data structures, tables, arrays, and variables. The functions provided in the components and the “— part” may be combined into a smaller number of components and “— parts” or may be further divided into additional components and “— parts.” In addition, the components and the “— parts” may be implemented to reproduce one or more central processing units (CPUs) in a device or a secure multimedia card.

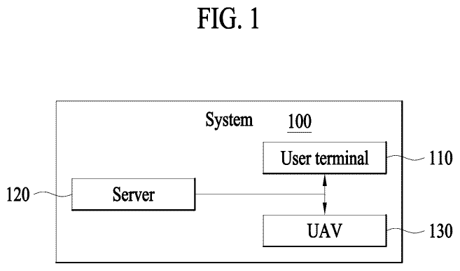

FIG. 1 is a schematic block diagram of a system for providing a location-based bidirectional key exchange protocol according to an example embodiment.

According to various example embodiments, a system 100 in the IoD environment that provides a location-based bidirectional key exchange protocol may include a server 120 that supports a key exchange protocol for bidirectional communication between a user terminal 110 and an UAV 130.

The server 120 may perform various control functions related to a key exchange protocol between the user terminal 110 and the UAV 130. The key exchange protocol may indicate that, in general, two entities (e.g., the user terminal 110 and the UAV 130) exchange symmetric keys and ensure security in communication by encrypting a message using the keys. Further, the key exchange protocol in the IoD environment may indicate that the user terminal 110 and the UAV 130 exchange keys through the server 120 for mutual communication.

In various example embodiments, the server 120 may use at least one of a symmetric key encryption system, a public key encryption system, a hash function, a message authentication code (hereinafter, “MAC”) and fuzzy extraction using biometric information. For example, according to an example embodiment, the server 120 may support a key exchange protocol between the user terminal 110 and the UAV 130 by using a symmetric key encryption system, a hash function and a MAC.

The user terminal 110 is a device that has mobility and includes a predetermined communication module. For example, the user terminal 110 may correspond to any one of a mobile phone, a smart phone, a portable console, a navigation device, a laptop computer and a tablet. The user terminal 110 may be referred to user equipment (UE), a mobile station, a terminal, a station (STA), a user device and a portable electronic device. In an example embodiment, the user terminal 110 may correspond to a device having a fixed location.

The user terminal 110 may be a device that transmits a control command to the UAV 130 or receives predetermined information (e.g., image information) from the UAV 130. For example, the control command may correspond to information for controlling an operation or mobility of the UAV 130.

The UAV 130 may be a device that performs a designated function without a pilot on board, and may correspond to an unmanned flight vehicle. For example, the UAV 130 may fly while changing direction or altitude in order to perform a designated function. For example, the UAV 130 may fly under the control of the server 120 or the user terminal 110 connected through communication and may selectively collect predetermined information. Further, the UAV 130 may autonomously fly and obtain image information, detect danger based on related information, and provide the related information to the server 120 or the user terminal 110 in an adjacent location.

Further, according to various example embodiments, the server 120 may include a processor and a database.

For example, the processor of the server 120 may generally control other elements of the server 120 in relation to an operation or function execution of the server 120. Further, the database may store instructions related to the operation of the processor and various information related to at least one user terminal 110 and the UAV 130 in various example embodiments.

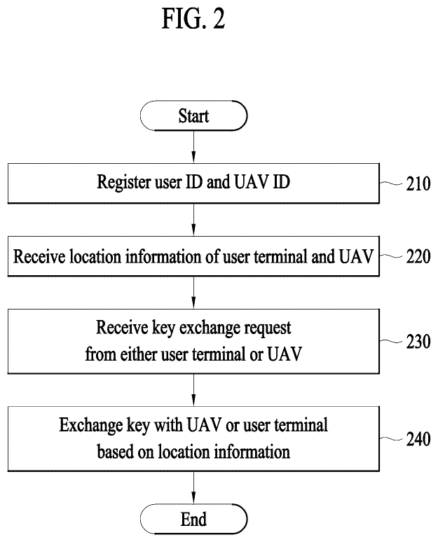

FIG. 2 is a flowchart illustrating a method for providing a key exchange protocol between a user terminal of an electronic device (e.g., the server 120) and an UAV according to an example embodiment.

Referring to FIG. 2, in operation 210, the server 120 may receive predetermined information for registering a user ID and an UAV ID from the user terminal 110 and the UAV 130, respectively.

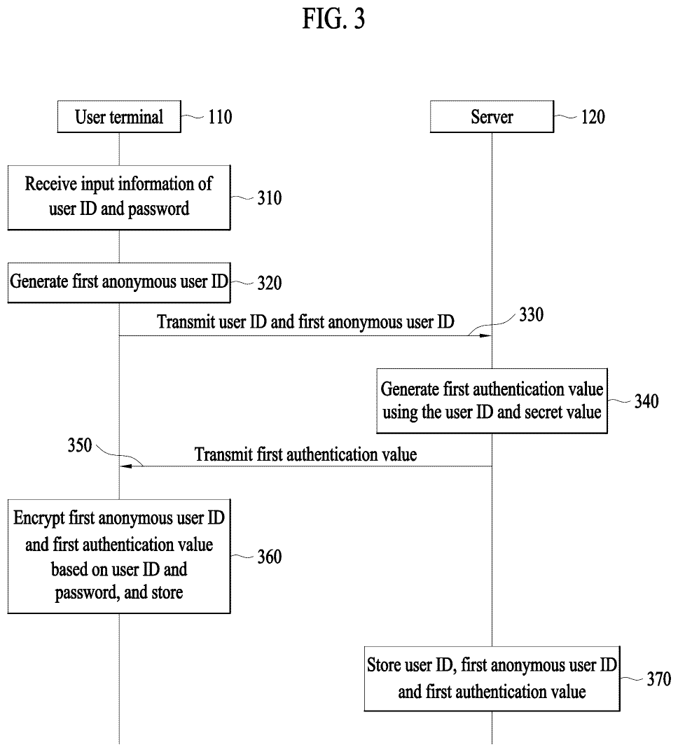

In the present disclosure, operations of registering the user ID will be described with reference to FIG. 3. FIG. 3 is a flowchart illustrating a method of registering a user ID from a user terminal to a server according to an example embodiment.

Specifically, in operation 310, the user terminal 110 may receive user input information of a user ID and password that are set by the user.

Further, in operation 320, the user terminal 110 may generate a first anonymous user ID corresponding to the user ID based on the user input. For example, at least one anonymous user ID generated by the user terminal 110 may correspond to a temporary one-time ID determined based on a random number value generated corresponding to the user ID.

In operation 330, the server 120 may receive information about the user ID and the first anonymous user ID from the user terminal 110.

In operation 340, the server 120 may generate a first authentication value using the user ID and a predetermined secret value (e.g., master secret key (msk)), and in operation 350, the server 120 may transmit the generated first authentication value to the user terminal 110.

Accordingly, in operation 370, the server 120 may store the user ID and the first anonymous user ID received from the user terminal 110 in a database (not illustrated) included in the server 120. Further, the server 120 may store the generated first authentication value in the database.

Further, in operation 360, the user terminal 110 may also encrypt the first anonymous user ID and the first authentication value information received from the server 120 based on the user ID and password information, and store the encrypted first anonymous user ID and the first authentication value in the memory of the user terminal 110. Accordingly, the server 120 may complete a process of registering a user ID corresponding to a specific user.

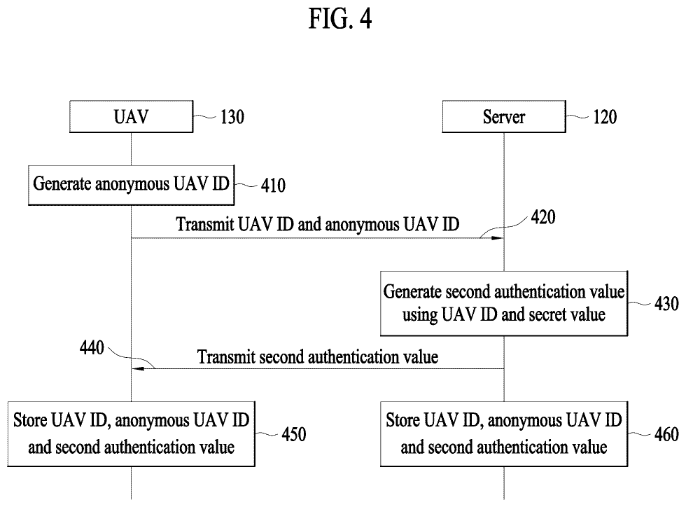

Further, similarly to the user terminal 110, in the UAV 130, a procedure of registering an UAV ID with the server 120 may be preferentially performed, and in this regard, it will be described with reference to FIG. 4.

Referring to FIG. 4, in operation 410, the UAV 130 may generate an arbitrary anonymous UAV ID based on a preset UAV ID, and in operation 420, the UAV 130 may transmit the UAV ID and the anonymous UAV ID to the server 120.

Further, in operation 430, the server 120 may generate a second authentication value using the UAV ID and a predetermined secret value (msk), and in operation 460, the server 120 may store the second authentication value in the database. Further, in operation 460, the server 120 may store the UAV ID and the anonymous UAV ID received from the UAV 130 in a database.

Further, in operation 440, the server 120 may transmit information about the generated second authentication value to the UAV 130, and in operation 450, the UAV 130 may store the UAV ID, the anonymous UAV ID and the second authentication value in a memory included in the UAV 130. Through the process, the server 120 may complete a procedure of registering an UAV ID corresponding to a specific UAV.

The server 120, as described in the above example embodiments, may receive registration information (ID information) for one or more users (or user terminals corresponding to each user) and one or more UAVs and the server 120 may store the information in a database.

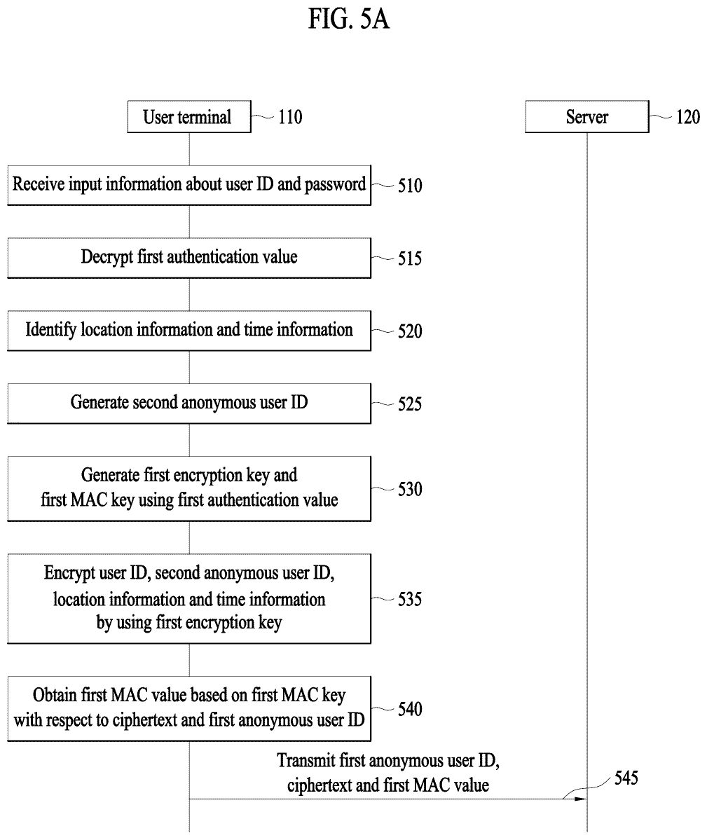

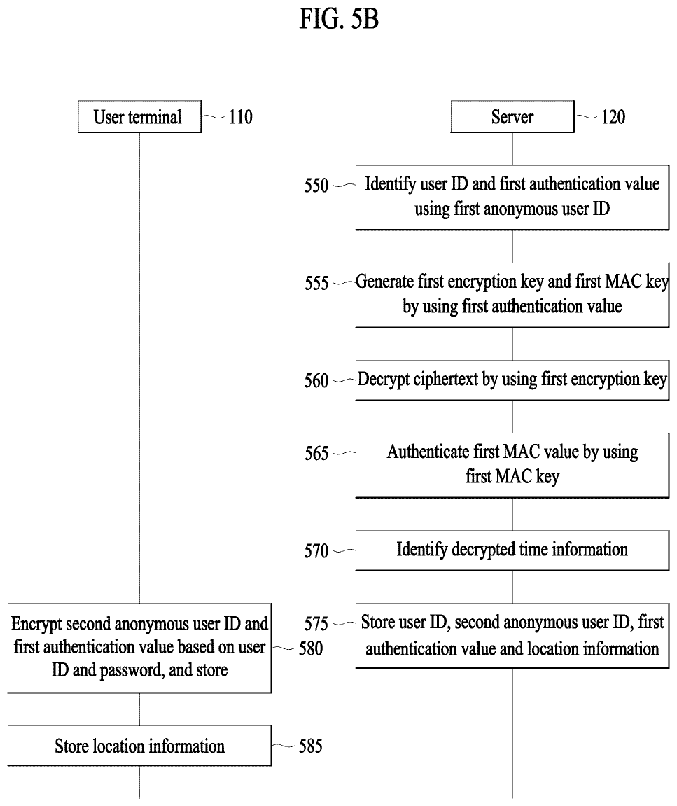

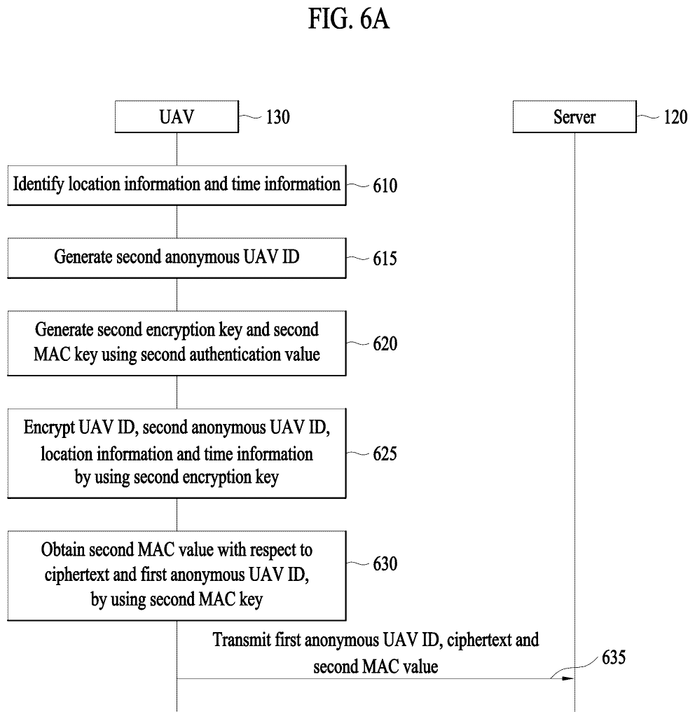

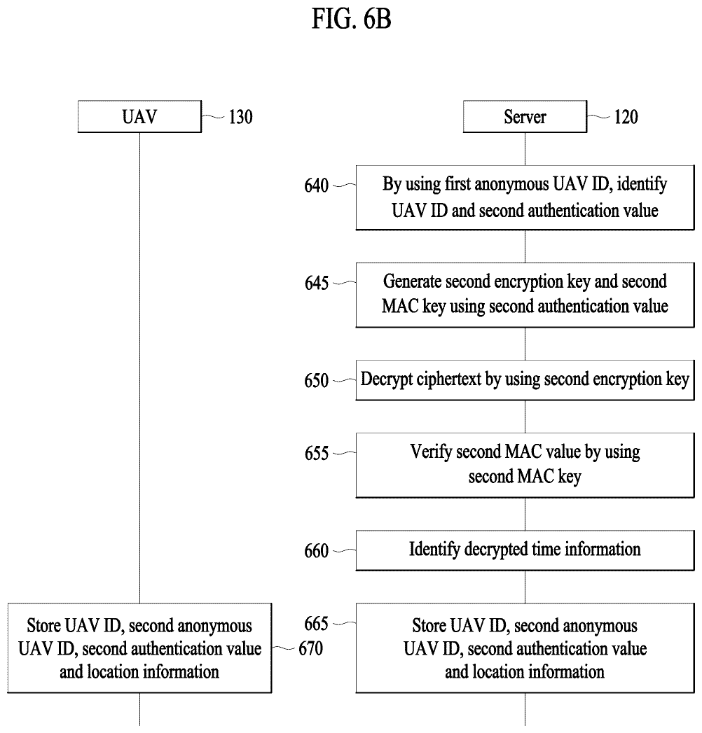

FIGS. 5A and 5B are flowcharts of a method for transmitting location information of the user terminal 110 according to an example embodiment, and FIGS. 6A and 6B are flowcharts of a method for transmitting location information of the UAV 130 according to an example embodiment. Hereinafter, a method for receiving location information in the server 120 according to various example embodiments of operation 220 of FIG. 2 will be described in detail with reference to FIGS. 5A to 6B.

In operation 220, according to an example embodiment, the server 120 may receive location information of the user terminal 110 and/or location information of the UAV 130.

If the user terminal 110 and/or the UAV 130 is to access the server 120 and is to transmit/receive predetermined information related to its registered ID to/from the server 120, the user terminal 110 and/or the UAV 130 may use a temporary anonymous ID (e.g., a anonymous user ID and an anonymous UAV ID), and thus improved security may be provided. For example, in operation 220, if the user terminal 110 or the UAV 130 provides each location information to the server 120, the user terminal 110 and the UAV 130 may transmit and receive information with the server 120 using an anonymous ID, and may update information (e.g., location information) related to the user ID or the UAV ID that are previously registered in the server 120.

Specifically, in operation 510 of FIG. 5A, the user terminal 110 may receive user input information about the user ID and password that are input in the time of the user ID registration.

In operation 515, through the received user ID and password, the user terminal 110 may decrypt the first anonymous user ID information and the first authentication value information that are encrypted and stored in the memory in the operation of registering the user ID.

Further, in operation 520, the user terminal 110 may obtain current location information of the user terminal 110 and time information corresponding to a sensing time of the location information using at least one sensor.

Further, in operation 525, the user terminal 110 may generate a second anonymous user ID as another random anonymous user ID based on the user ID.

Further, in operation 530, the user terminal 110 may generate a first encryption key and a first MAC key by using the first authentication value obtained from the decryption. Further, since the server 120 also stores the first authentication value in a database, when receiving a first anonymous user ID from the user terminal 110, information of the first authentication value corresponding to the first user may be identified. Further, like the user terminal 110, since the server 120 may generate a first encryption key and a first MAC key using the first authentication value, information transmitted as encrypted information or a MAC at the user terminal 110 side may be identified or verified by the server 120.

For example, in operation 535, using the first encryption key, the user terminal 110 may encrypt a user ID, a second anonymous user ID, location information of the user terminal 110, and time information corresponding to the location information. Further, in operation 540, the user terminal 110 may obtain a first MAC value by making the encrypted ciphertext (e.g., ciphertext regarding a user ID, a second anonymous user ID, location information of the user terminal 110, and time information of the user terminal 110) and the first anonymous user ID into a MAC by using the first MAC key.

In operation 545, the server 120 may receive information on the ciphertext, a first anonymous user ID and a first MAC value from the user terminal 110.

As described above, in operation 550, the server 120 may identify a user ID and a first authentication value corresponding to the first anonymous user ID from the database using the received first anonymous user ID. Further, in operation 555, the server 120 may generate a first encryption key and a first MAC key by using the identified first authentication value.

For example, in operation 560, the server 120 may decrypt the ciphertext (e.g., ciphertext for a user ID, a second anonymous user ID, location information of the user terminal 110 and time information of the user terminal 110) received from the user terminal 110 by using the first encryption key, and therefrom, the server 120 may identify the user ID, the second anonymous user ID, location information and time information. Further, in operation 565, the validity (or integrity) of the first MAC value may be authenticated (or verified) using the first MAC key.

Further, in operation 570, based on the time information obtained through the decryption, the server 120 may compare the time information corresponding to the point in time at which the location information of the user terminal 110 is obtained with the current time and identify whether there is a difference (time difference) greater than a specified size. For example, if there is time difference between the current time information and the received time information beyond the preset time range, the server 120 may disregard the location information without storing (or updating) the location information of the user terminal 110. For example, in operation 575, if it is determined that a large time difference does not occur between the current time and the time at which the location information is obtained, the server 120 may store (or update) the location information in a database as current location information of the user terminal 110.

For example, the server 120 may store the location information together with a user ID, a second anonymous user ID and a first authentication value, and the server 120 may predict the current location of the user terminal corresponding to the user ID based on the stored location information.

Further, in operation 580, the user terminal 110 may encrypt the generated second anonymous user ID and the first authentication value again, based on the user ID and password, and store the encrypted second anonymous user ID and first authentication value in a memory include in the user terminal 110. For example, in operation 585, the user terminal 110 may also store the location-based information provided to the server 120 in the memory together with the encrypted information.

In a manner similar to the method of providing location information from the user terminal 110, the server 120 may also receive (or update) location information of the UAV 130 in operation 220.

With regard thereto, referring to FIGS. 6A and 6B together, in operation 610, the UAV 130 according to an example embodiment may sense location information of the UAV 130 by using at least one sensor at a specific time point. For example, the UAV 130 may identify time information corresponding to the sensing time of the location information together with the location information.

In operation 615, in order to guarantee the anonymity of the UAV ID corresponding to the unique information of the UAV when transmitting and receiving information with the server 120, the UAV 130 may generate at least one anonymous UAV ID (e.g., a second anonymous UAV ID). In operation 620, the UAV 130 may process specific information to be transmitted to the server 120, by generating a second encryption key and a second MAC key using the second authentication value stored in the memory of the UAV 130 in the operation of registering the UAV ID to the server.

For example, in operation 625, the UAV 130 may encrypt an UAV ID, a second anonymous UAV ID, location information and time information using a second encryption key.

Further, in operation 630, the UAV 130 may obtain a second MAC value, by making the ciphertext (e.g., a ciphertext for UAV ID, a second anonymous UAV ID, location information and time information) for the encrypted information and the first anonymous UAV ID used when registering the UAV ID, as a MAC, using the second MAC key.

Further, in operation 635, the server 120 may receive ciphertext, a first anonymous UAV ID and a second MAC value from the UAV 130.

For example, in operation 640 of FIG. 6B, by using the first anonymous UAV ID received from the UAV 130, the server 120 may identify the pre-stored UAV ID mapped together with the first anonymous UAV ID and the second authentication value. Further, in operation 645, the server 120 may generate a second encryption key and a second MAC key using the second authentication value.

For example, in operation 650, the server 120 may decrypt the received ciphertext (e.g., a ciphertext for UAV ID, a second anonymous UAV ID, location information and time information) using the second encryption key, and in operation 655, the server 120 may verify whether the second MAC value is valid using the second MAC key.

Further, in operation 660, the server 120 may identify whether the time information is valid by comparing the time information with current time information based on a preset condition based on time information among the decrypted information, and if the time information is identified as valid, the server 120 may store location information corresponding to the time information as location information of the currently UAV 130. For example, if the time difference between the time information and the current time is less than a threshold value according to a set reference condition, the server 120 may determine that the time information is valid.

In this case, in operation 665, the server 120 may map the location information together with the UAV ID, the second anonymous UAV ID and the second authentication value, and update and store the location information in a database.

Further, in operation 670, the UAV 130 may also store the UAV ID, the second anonymous UAV ID, the second authentication value and location information in a memory included in the UAV 130.

Accordingly, the server 120 may receive, update and manage location information of a pre-registered user (the user terminal 110 corresponding to the user) and/or the UAV 130.

According to various example embodiments, the server 120 may receive location information on the user terminal 110 logged in by a user or the UAV 130 in flight at a preset time or every designated time period, and periodically identify location information of each device.

Further, in operation 230, the server 120 may receive a key exchange request for a counterpart device from either the user terminal 110 or the UAV 130. Further, in operation 240, the server 120 may identify the validity of the user terminal 110 or the UAV 130 requesting the key exchange, and the server 120 may play a role of relaying key exchange with the UAV 130 or the user terminal 110 based on each location information.

In various example embodiments, the user terminal 110 may be plural and the UAV 130 may be plural. For example, if it is determined that the user terminal 110 requests key exchange with the UAV 130 under valid conditions, the server 120 may identify the UAV 130 adjacent to the user terminal 110 based on the location information of the user terminal 110, and the server 120 may control key exchange with the UAV 130 for the key exchange process. Further, even when key exchange with the user terminal 110 is requested from the UAV 130 under valid conditions, the server 120 may identify the user terminal 110 located within a nearby location range based on the location information of the UAV 130 and a preset condition. The server 120 may control key exchange and information transmission/reception to be performed for at least some (e.g., all of the user terminals 110 registered with user IDs located within a predetermined radius, or the user terminal 110 corresponding to the case where a user agrees to receive a key request from the UAV 130) corresponding to the user terminal 110.

To be more specific with respect to operation 230 and operation 240, in an example embodiment, the user terminal 110 may transmit predetermined information related to a key exchange request to the server 120 in order to perform a bidirectional key exchange protocol with the UAV 130.

For example, the user terminal 110 may transmit key exchange request information to the server 120 in a manner similar to that described with reference to operation 510 to operation 540 of FIG. 5A.

For example, the user terminal 110 may receive input information about a user ID and password, and decrypt the encrypted first authentication value (see operation 580 of FIG. 5B) therefrom. Further, the user terminal 110 may identify the latest time information at the point at which the key exchange request is to be performed, and since the user terminal 110 is to transmit/receive information with the server 120, the user terminal 110 may generate a third anonymous user ID and random number information as a new anonymous user ID. The user terminal 110 may generate a first encryption key and a first MAC key by using the first authentication value. The user terminal 110 may generate ciphertext by encrypting a user ID, a third anonymous user ID, location information, latest time information and a random number by using the first encryption key. Further, a third MAC value may be obtained by making the ciphertext, the second anonymous user ID (or the first anonymous user ID), and the server ID, into a MAC, by using the first MAC key.

The server 120 may receive a second anonymous user ID, a server ID, a ciphertext and a third MAC value from the user terminal 110.

The server 120 may identify that the information received from the user terminal 110 is transmitted to the server 120 based on the server ID. For example, even if there are multiple other servers on the network, the server 120 may use the server ID to identify that the corresponding information is information transmitted to the server 120 itself. For this, if specific information is received from the outside (e.g., a user terminal and an UAV), the server 120 may first identify whether a server ID corresponding to the server 120 is included in the received information, and may process the received information only if a corresponding server ID is included. Further, the process is not specifically described above, but it is obvious that the same may be applied to at least one of the operation of registering a user ID, the operation of registering an UAV ID and the operation of transmitting location information, which are described with reference to FIGS. 3 to 6B.

The server 120 may identify a pre-stored user ID and a first authentication value (see operation 575 of FIG. 5B) from the database using the received second anonymous user ID. The server 120 may generate a first encryption key and a first MAC key using the first authentication value, and the server 120 may decrypt ciphertext (e.g., a ciphertext in which a user ID, a third anonymous user ID, location information, latest time information and random number information are encrypted) using the first encryption key and verify (or authenticate) the third MAC value by using the first MAC key. The server 120 may identify the decrypted latest time information, and if it is determined that the location information is valid based on the latest time information, the server 120 may search for at least one UAV 130 (e.g., the nearest UAV) located within a range based on the location information.

Here, the server 120 may identify an authentication value (e.g., a second authentication value) corresponding to the searched UAV 130, and may generate an encryption key and a MAC key using the authentication value. For example, the server 120 may identify the second authentication value corresponding to the searched adjacent UAV 130 from the database (see operation 460 of FIG. 4), and the server 120 may generate a second encryption key and a second MAC key using the second authentication value. The server 120 may generate ciphertext by encrypting a user's anonymous ID (a third anonymous user ID) and a random number value generated by the user by using the generated second encryption key. Further, the server 120 may make the ciphertext, the server ID, and the anonymous ID of the UAV (e.g., the second anonymous UAV ID) as a MAC, by using the second MAC key. Further, the server 120 may transmit the server ID, an anonymous ID of the UAV (e.g., a second anonymous UAV ID) and ciphertext to the searched UAV 130.

Further, the UAV 130 may generate a second encryption key and a second MAC key using the second authentication value of the UAV 130 (see operation 450 of FIG. 4), and the UAV 130 may decrypt the ciphertext received through the second encryption key and the second MAC key, and verify the received MAC value. The UAV 130 may generate a third anonymous UAV ID as a new anonymous ID and may also generate a second random number value. The UAV 130 may encrypt the generated third anonymous UAV ID and the second random number value, convert ciphertext into a MAC and transmit the ciphertext to the server.

Again, the server 120 may decrypt the received ciphertext (e.g., a ciphertext in which the third anonymous UAV ID and the second random number are encrypted) based on the second authentication value and perform MAC verification. The server 120 may re-encrypt the decrypted information (e.g., the third anonymous UAV ID and a second random number value) by using the first authentication value of the user terminal 110 to generate a MAC, and may transmit the MAC to the user terminal 110. Through the process, the user terminal 110 may identify and store the anonymous ID (the third anonymous UAV ID) of the UAV 130 and the second random number value, and the UAV 130 may also identify and store the anonymous ID of the user terminal 110 (the third anonymous user ID) and random number values. Based on the stored anonymous ID and random number value, the user terminal 110 and the UAV 130 may perform bidirectional communication.

With regard to operation 230 and operation 240, requesting a key exchange from the UAV 130 to the neighboring user terminal 110 may also be performed similarly to the requesting a key exchange from the user terminal 110 described above.

For example, the UAV 130 may identify (extract) latest time information at the point in time at which the key exchange request is to be performed, and the UAV 130 may generate a new anonymous ID (e.g., a third anonymous UAV ID) and a random number value (e.g., a second random number value). The UAV 130 may encrypt the latest time information, third anonymous UAV ID, and second random number information by using a second authentication value to generate a MAC, and may transmit related information to the server 120.

The server 120 may further include identifying whether the UAV 130 is a device registered to the server 120 based on the received information. As a result of the identification, if the UAV 130 of which key exchange request information is received is identified as a device that is registered in the server 120, the server 120 may identify the user terminal 110 located within a radius corresponding to the location information of the UAV 130 based on the location information of at least one user terminal (e.g., the user terminal 110) stored in the database. At this time, the identified user terminals 110 may include all user terminals 110 located within the radius, but it is not limited thereto, and it is obvious that it may be selectively determined based on user settings.

The server 120 may identify an anonymous ID (e.g., a second anonymous user ID) and an authentication value (e.g., a first authentication value) stored in the database corresponding to at least one verified user terminal 110. Based on the authentication value (e.g., the first authentication value), the server 120 may encrypt the third anonymous UAV ID and the second random number value to make a MAC, and may transmit each information to the corresponding user terminal 110.

Upon receiving such information, the user terminal 110 may decrypt the authentication value (e.g., the first authentication value) based on the user ID and password and may decrypt the received information by using the first authentication value and operate MAC verification to identify the anonymous ID and random number value of the adjacent UAV 130. The user terminal 110 may generate a new anonymous ID again and generate a random number value, the user terminal 110 may operate encryption and generate a MAC by using the authentication value to transmit the corresponding information to the server 120. The server 120 may decrypt the received information by using the authentication value and operate MAC verification in order to identify the information. Again, if the server 120 encrypts the information using an authentication value (e.g., a second authentication value) corresponding to the UAV 130 and generate a MAC, and transmit the MAC to the UAV 130, the UAV 130 may decrypt the information (e.g., the user's anonymous ID and a random number generated from the user terminal 110) using the authentication value corresponding to the UAV 130 and operate MAC verification for identification.

Accordingly, the user terminal 110 and the UAV 130 may generate session keys based on an anonymous ID and random number values, and may safely perform bidirectional communication through the obtained session key. Further, if there is possibility that the anonymous ID is to be exposed to the outside based on the location and time pattern of the user terminal 110 or the UAV 130, as the user terminal 110 and the UAV 130 use a new anonymous ID every time, storing anonymity “G security” may be secured.

Meanwhile, in the present disclosure and drawings, example embodiments are disclosed, and certain terms are used. However, the terms are only used in general sense to easily describe the technical content of the present disclosure and to help the understanding of the present disclosure, but not to limit the scope of the present disclosure. It is apparent to those of ordinary skill in the art to which the present disclosure pertains that other modifications based on the technical spirit of the present disclosure may be implemented in addition to the example embodiments disclosed herein.

1. An electronic device comprising:
a database; and
a processor,
wherein the processor is configured to:
receive a user ID, at least one anonymous user ID corresponding to the user ID and location information of a user terminal from the user terminal;
receive an unmanned aerial vehicle (UAV) ID, at least one anonymous UAV ID corresponding to the UAV ID and location information of an UAV from the UAV; and
in response to receiving key exchange request information from the user terminal or the UAV, provide a key exchange protocol between the user terminal and the UAV based on the location information of the user terminal and the location information of the UAV.

2. The electronic device of claim 1, wherein the processor is configured to:
generate a first authentication value corresponding to the user terminal by using the user ID and a secret value of a server and store the first authentication value in the database;
transmit the first authentication value to the user terminal; and
identify information encrypted based on the first authentication value and received from the user terminal by using the first authentication value.

3. The electronic device of claim 2, wherein the information encrypted and received from the user terminal includes at least one anonymous user ID.

4. The electronic device of claim 1, wherein the processor is configured to:
generate a second authentication value corresponding to the UAV using the UAV ID and a secret value of a server, and store the second authentication value in the database;
transmit the second authentication value to the UAV; and
identify information encrypted based on the second authentication value and received from the UAV by using the second authentication value.

5. The electronic device of claim 4, wherein the information encrypted and received from the UAV includes at least one anonymous UAV ID.

6. The electronic device of claim 1, wherein the processor is configured to:
receive time information corresponding to the location information from the user terminal or the UAV; and
store the location information in the database based on whether the time information is valid.

7. A method of providing a location-based bidirectional key exchange protocol, the method comprising:
registering user information corresponding to at least one user terminal based on user ID information received from the at least one user terminal;
registering at least one UAV information based on UAV ID information received from at least one UAV;
receiving location information on at least one of the at least one user terminal or the at least one UAV; and
in response to receiving key exchange request information from any one of the at least one user terminal and the at least one UAV, providing a key exchange protocol between any one of the at least one user terminal and any one of the at least one UAV based on the location information.

8. The method of claim 7, further comprising:
in response to receiving the user ID information, transmitting a first authentication value generated by using the user ID information to the at least one user terminal; and
in response to receiving the UAV ID information, transmitting a second authentication value generated by using the UAV ID information to the at least one UAV.

9. The method of claim 7, wherein the receiving the location information further includes:
receiving time information corresponding to the location information; and
storing the location information based on whether the time information is valid.

10. A computer-readable non-transitory recording medium having a program for executing a method for providing a location-based bidirectional key exchange protocol on a computer, wherein the method for providing a location-based bidirectional key exchange protocol includes:
registering user information corresponding to at least one user terminal based on user ID information received from the at least one user terminal;
registering at least one UAV information based on UAV ID information received from at least one UAV;
receiving location information on at least one of the at least one user terminal or the at least one UAV; and
in response to receiving key exchange request information from any one of the at least one user terminal and the at least one UAV, providing a key exchange protocol between any one of the at least one user terminal and any one of the at least one UAV based on the location information.
